(19) United States
(12) Patent Application Publication
(10) Pub. No.: US 2026/0189433 A1
(43) Pub. Date: Jul. 2, 2026

(54) TERMINAL AND OPERATION METHOD THEREOF

(71) Applicant: SAMSUNG ELECTRONICS CO., LTD., Suwon-si (KR)

(72) Inventors: Joo-Han KIM, Suwon-si (KR); Jeongsoon PARK, Suwon-si (KR); Youngseok JUNG, Suwon-si (KR); Hanyoung JO, Suwon-si (KR)

(73) Assignee: SAMSUNG ELECTRONICS CO., LTD., Suwon-si (KR)

(21) Appl. No.: 19/278,154

(22) Filed: Jul. 23, 2025

(30) Foreign Application Priority Data
Jan. 2, 2025 (KR) 10-2025-0000147

(51) Int. Cl. H04L 25/02

(52) U.S. Cl. CPC H04L 25/0224

(57) ABSTRACT

A terminal and an operation method thereof are provided. The operation method includes identifying a resource group corresponding to the terminal, identifying, within the resource group, a first resource unit and a second resource unit, identifying first channel characteristic information corresponding to the first resource unit and second channel characteristic information corresponding to the second resource unit based on reference signals transmitted in the first resource unit and the second resource unit, and storing information indicating a variation between the first channel characteristic information and the second channel characteristic information as the second channel characteristic information corresponding to the second resource unit.

### CROSS-REFERENCE TO RELATED APPLICATIONS

This application is based on and claims the benefit of Korean Patent Application No. 10-2025-0000147, filed on Jan. 2, 2025, in the Korean Intellectual Property Office, the disclosure of which is incorporated herein by reference in its entirety.

### BACKGROUND

### 1. Field

One or more example embodiments relate to a terminal in a wireless communication environment and an operation method thereof.

### 2. Description of Related Art

In a wireless communication environment, the states of wireless channels vary unpredictably across both the time and frequency domains. Receivers can estimate channel characteristic information to determine the degree of distortion in signals received through the wireless channels, and restore the transmitted signal from the received signal based on the estimated channel characteristic information.

However, when it comes to storing channel characteristic information, a problem rises in that the size of the buffer or memory required to store the channel characteristic information increases as the number of antennas or carriers increases.

### SUMMARY

One or more embodiments provide a terminal and an operation method thereof to reduce a size of a buffer used for storing channel characteristic information, by storing channel characteristic information in a compressed form.

According to an aspect, there is provided an operation method including identifying a resource group corresponding to the terminal, identifying, within the resource group, a first resource unit and a second resource unit, identifying first channel characteristic information corresponding to the first resource unit and second channel characteristic information corresponding to the second resource unit based on reference signals transmitted in the first resource unit and the second resource unit, and storing information indicating a variation between the first channel characteristic information and the second channel characteristic information as the second channel characteristic information corresponding to the second resource unit.

According to another aspect, there is also provided a terminal including a transceiver, a buffer, and a processor configured to identify a resource group corresponding to the terminal, identify, within the resource group, a first resource unit and a second resource unit, identify first channel characteristic information corresponding to the first resource unit and second channel characteristic information corresponding to the second resource unit based on reference signals transmitted in the first resource unit and the second resource unit, and store indicating a variation between the first channel characteristic information and the second channel characteristic information as the second channel characteristic information corresponding to the second resource unit.

According to still another aspect, there is provided a wireless communication system including a terminal and a base station, wherein the base station is configured to transmit to the terminal, indication information indicating a resource group corresponding to the terminal, and the terminal is configured to identify the resource group based on the indication information received from the base station, identify, within the resource group, a first resource unit and a second resource unit, identify first channel characteristic information corresponding to the first resource unit and second channel characteristic information corresponding to the second resource unit based on reference signals transmitted in the first resource unit and the second resource unit, and store information indicating a variation between the first channel characteristic information and the second channel characteristic information as the second channel characteristic information corresponding to the second resource unit.

According to example embodiments, a buffer size required for storing channel characteristic information in a terminal may be reduced by storing only a difference between channel characteristic information corresponding to adjacent subcarriers, instead of storing the entire channel characteristic information for each subcarrier.

According to example embodiments, the buffer size may be reduced by storing a difference between channel characteristic information corresponding to adjacent symbols, instead of storing the entire channel characteristic information corresponding to each symbol.

Effects of the present disclosure are not limited to those described above, and other effects may be made apparent to those skilled in the art from the following description.

None of the description in this application should be read as implying that any particular element, step, or function is an essential element that must be included in the claim scope. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF DRAWINGS

These and/or other aspects, features, and advantages of the invention will become apparent and more readily appreciated from the following description of example embodiments, taken in conjunction with the accompanying drawings of which:

FIG. 1 is a diagram illustrating a wireless communication system according to one or more example embodiments;

FIG. 2 is a diagram for describing a process of a terminal storing channel characteristic information and restoring data using the stored channel characteristic information according to one or more example embodiments;

FIG. 3 is a diagram illustrating a reception structure of a multiple-input multiple-output orthogonal frequency division multiplexing (MIMO-OFDM) system according to one or more example embodiments;

FIGS. 4A and 4B are diagrams for describing a process of a terminal storing channel characteristic information in a frequency domain according to one or more example embodiments;

FIGS. 5A and 5B are diagrams for describing a process of a terminal storing channel characteristic information in a time domain according to one or more example embodiments;

FIGS. 6A and 6B are diagrams for describing a process of a terminal storing channel characteristic information according to one or more example embodiments;

FIGS. 7A and 7B are diagrams for describing a result of an operation method executed in a terminal according to one or more example embodiments;

FIG. 8 is a flowchart illustrating an operation method of a terminal according to one or more example embodiments; and

FIG. 9 is a block diagram of a terminal according to one or more example embodiments.

### DETAILED DESCRIPTION

Terms used in the example embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the present disclosure. Accordingly, it should be noted that the terms used herein should be construed based on practical meanings thereof and the whole content of this specification rather than being simply construed based on names of the terms.

In the entire specification, when an element is referred to as “comprising” or “including” another element, the element should not be understood as excluding other elements as long as there is no special conflicting description, and the element may include at least one other element.

Throughout the specification, expression “at least one of a, b, and c” may include ‘a only’, ‘b only’, ‘c only’, ‘a and b’, ‘a and c’, ‘b and c’, or ‘all of a, b, and c’.

The “terminal” referred hereinafter may be embodied as a computer or a portable device that can access a server or another terminal through a network. In the present disclosure, the computer may include, for example, a notebook computer, a desktop computer, and a laptop equipped with a web browser, and the portable device, for example, as a wireless communication device that guarantees portability and mobility, may include all kinds of handheld wireless communication devices, such as a communication-based terminal supporting international mobile telecommunication (IMT), code division multiple access (CDMA), w-code division multiple access (W-CDMA), long-term evolution (LTE), and the like, a smartphone, and a tablet PC.

In the following description, example embodiments of the present disclosure will be described in detail with reference to the drawings so that those skilled in the art can easily carry out the present disclosure. The present disclosure may be applied in many different forms and is not limited to the embodiments described herein.

Hereinafter, example embodiments of the present disclosure will be described with reference to the drawings.

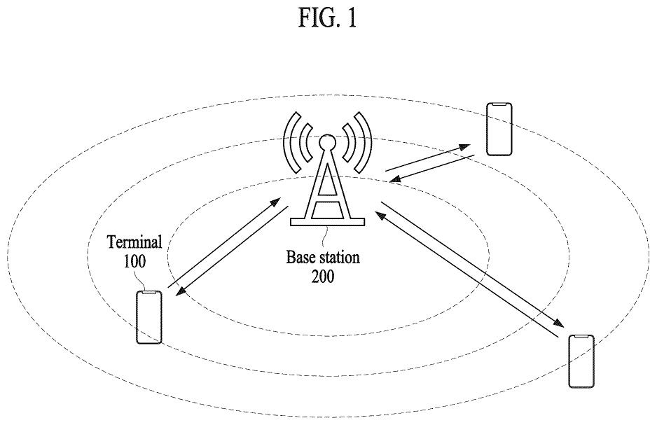

FIG. 1 is a diagram illustrating a wireless communication system according to one or more example embodiments.

Referring to FIG. 1, the wireless communication system may include one or more terminals 100 and a base station 200. Components related to the example embodiments are shown with respect to the system illustrated in FIG. 1, additional components other than the components illustrated in FIG. 1 may also be included.

According to one or more example embodiments, a terminal 100 may operate as a wireless communication device, and may refer to various devices capable of transmitting and receiving data and/or control information through communication with the base station 200. For example, the terminal 100 may include a user equipment, a mobile station (MS), a mobile terminal (MT), a user terminal (UT), a subscribe station (SS), a wireless device, a portable device, and the like.

According to one or more example embodiments, the base station 200 may refer to a fixed station which transmits and receives data and/or control information through communication with the terminal 100 and/or other base station. For example, the base station 200 may include a Node B, a next generation Node B (gNB), an evolved-Node B (eNB), a base transceiver system (BTS), an access point (AP), and the like.

According to one or more example embodiments, the terminal 100 may communicate with the base station 200 within a cell-coverage of the base station 200. For example, the terminal 100 and the base station 200 may communicate with each other through a downlink channel and an uplink channel. When communicating through the downlink channel, the terminal 100 and the base station 200 may correspond to a wireless receiver and a wireless transmitter respectively, and when communicating through the uplink channel, the terminal 100 and the base station 200 may correspond to a wireless transmitter and a wireless receiver respectively.

According to one or more example embodiments, a wireless communication network between the terminal 100 and the base station 200 may support a number of users to communicate by sharing available network resources. For example, in a wireless communication network, information may be transmitted using different methods, such as code division multiple access (CDMA), frequency division multiple access (FDMA), time division multiple access (TDMA), orthogonal frequency division multiple access (OFDMA), and single carrier frequency division multiple access (SC-FDMA).

According to one or more example embodiments, the base station 200 may transmit a downlink signal (DLS) including data to the terminal 100 through at least one antenna port. For example, the base station 200 may precode a data signal (or a data symbol) and a reference signal (or a reference symbol), and transmit the precoded data signals and precoded reference signals to the terminal 100 through the downlink channel.

Here, the reference signal, as a signal used for estimating a channel of a data signal, may be referred to as a pilot. For example, the reference signal may include a demodulation reference signal (DMRS), a common reference signal (CRS), a channel state information reference signal (CSI-RS), and the like, used for estimating a channel of a particular terminal. However, the reference signal may also include various kinds of signals other than the above-described signals, and is not limited to the above-description.

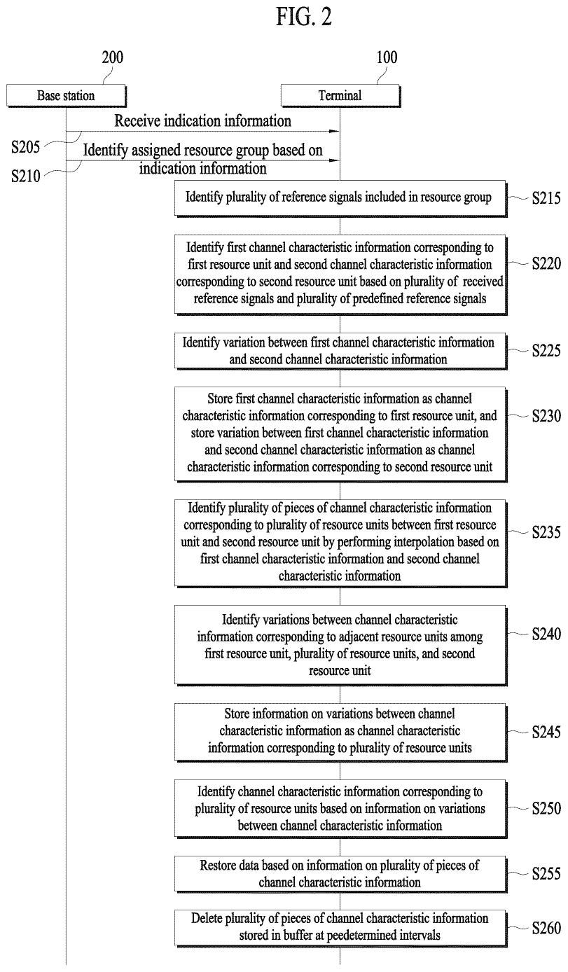

FIG. 2 is a diagram for describing a process of the terminal 100 storing channel characteristic information and restoring data using the stored channel characteristic information according to one or more example embodiments.

In operation S205, the terminal 100 may receive indication information from the base station 200 according to one or more example embodiments. For example, the terminal 100 may receive downlink control information (DCI) from the base station 200 through a physical downlink control channel (PDCCH). The DCI include resource scheduling and transmission parameter settings.

The indication information may include various parameters necessary for decoding downlink data. For example, the indication information may include information on a target transmission location to which data will be transmitted (e.g., a physical resource block (PRB) allocation indicating where the data will be transmitted in the frequency-time grid, a modulation method used, a coding rate, identification data used for retransmission requests (e.g., a hybrid automatic repeat request (HARQ) process ID for managing retransmission requests), or configuration settings for a reference signal used in channel estimation for a physical downlink shared channel (PDSCH) (e.g., a demodulation reference signal (DMRS) pattern and antenna port configuration, used for channel estimation in the PDSCH).

In operation S210, the terminal 100 may identify an assigned resource group based on the indication information according to one or more example embodiments. For example, the terminal 100 may identify an assigned resource group based on DCI received from the base station. Specifically, the terminal 100 may parse a DCI payload to extract information on time-frequency resource allocation and determine the associated resource group for PDSCH reception.

The resource group may correspond to one or more resource blocks (RB). However, the resource group may also set to be in different forms and configurations such as bandwidth parts (BWPs), resource block groups (RBGs), or specific time-domain allocations, and is not limited to the above-description.

In operation S215, the terminal 100 may identify a plurality of reference signals included in the resource group according to one or more example embodiments. For example, the terminal 100 may identify a first resource unit in which a reference signal is located and a second resource unit in which the next reference signal is located, from the assigned resource group, based on reference signal settings information. Then, the terminal 100 may identify a first reference signal and a second reference signal transmitted in the first resource unit and the second resource unit respectively.

The resource unit may refer to a resource element (RE), however, the resource unit may also be set to have different forms and configurations, and is not limited to the above-description.

In operation S220, the terminal 100 may identify first channel characteristic information corresponding to the first resource unit and second channel characteristic information corresponding to the second resource unit based on the plurality of received reference signals and a plurality of predefined reference signals. More specifically, the terminal 100 may acquire channel characteristic information by comparing a reference signal received at the base station 200 and a reference signal received at the terminal 100 received.

For example, the base station 200 may insert a predefined reference signal value x(n) into the nth resource unit and transmit it to the terminal 100, and the terminal 100 may receive a reference signal y(n) from the nth resource unit. During transmission, an amplitude of received x(n) may increase or decrease due to channel effects, a phase of a signal may change, a noise may be added. As a result, the received reference signal y(n) may be expressed as shown in equation (1) below. Then, the terminal 100, as shown in equation (2), may identify the nth channel characteristic information ĥ(n) corresponding to the nth resource unit by comparing x(n) and y(n).

$$y ( n ) = h ( n ) * x ( n ) + z ( n ) \qquad ( 1 )$$

$$\hat{h} ( n ) = \frac{y ( n )}{x ( n )} = {I}_{n} + j Qn \qquad ( 2 )$$

Here, h(n) denotes a channel coefficient that includes information on frequency response, channel gain, and phase, while z(n) denotes noise or channel noise. In addition, ĥ(n), as information on estimated characteristics of a channel, may refer to channel characteristic information, channel state information, a channel state value, a channel estimation value, and the like, but terms indicating thereof are not limited to the aforementioned terms.

In operation S225, the terminal 100 may identify variation between the first channel characteristic information and the second channel characteristic information according to one or more example embodiments. For example, the terminal 100 may calculate a difference between the first channel characteristic information and the second channel characteristic information for each of a real value and an imaginary value.

$$\{ \begin{matrix}D e l t {a}_{I} ( 1 ) = {\hat{h}}_{I} ( 2 ) - {\hat{h}}_{I} ( 1 ) = {I}_{2} - {I}_{1} \\ D e l t {a}_{Q} ( 1 ) = {\hat{h}}_{Q} ( 2 ) - {\hat{h}}_{Q} ( 1 ) = {Q}_{2} - {Q}_{1}\end{matrix} \qquad ( 3 )$$

Here, ĥ₁(n) and ĥ_{Q}(n) denote in-phase (I) and quadrature (Q) components of the estimated channel characteristic information ĥ(n), respectively, for the n-th resource unit.

In operation 230, according to one or more example embodiments, the terminal 100 may store the first channel characteristic information as channel characteristic information corresponding to the first resource unit, and may store the information on difference between the first channel characteristic information and the second characteristic information as channel characteristic information corresponding to the second resource unit. More specifically, the terminal 100 may store the first channel characteristic information in a buffer using a relatively more number of bits (i.e., a first size), as channel characteristic information corresponding to the first resource unit. Also, the terminal 100 may store the information on variation between the first channel characteristic information and the second channel characteristic information in the buffer using a relatively less number of bits (i.e., a second size), as channel characteristic information corresponding to the second resource unit.

For example, the terminal 100 may store the in-phase component I₁ and quadrature component Q₁ of the first resource unit in the buffer using 12 bits each, as channel characteristic information corresponding to the first resource unit. These values may serve as reference or anchor values. In addition, the terminal 100 may store the differences I₂-I₁ and Q₂-Q₁ representing the relative variation for the second resource unit, in the buffer using 7 bits each as channel characteristic information corresponding to the second resource unit. This approach may reduce the amount of memory required for subsequent channel estimates.

Here, as described above, the second size may be set to 7 bits which is a fixed value smaller than the first size of 12 bits, but this is merely an example, and is not limited to the aforementioned values. The first and second sizes may be configured differently depending on system requirements, target compression ratios, or hardware constraints.

According to one or more example embodiments, the terminal 100 may adaptively determine a bit size used to store which channel characteristic information. More specifically, the terminal 100, based on a tracking reference signal (TRS), may estimate a changing trend (e.g., a variation trend) of channel characteristic information corresponding to the assigned resource group, and adaptively determine the bit size used for storing the channel characteristic information corresponding to the second resource unit, based on the changing trend of the channel characteristic information.

As an example, the terminal 100 may identify that the variation in channel characteristic information corresponding to the assigned resource group is relatively small based on the tracking reference signal received from the base station 200. Accordingly, the terminal 100 may determine a smaller bit size (second size) to represent the variation between the first channel characteristic information and the second channel characteristic information.

As another example, the terminal 100 may identify that the variation in the channel characteristic information corresponding to the assigned resource group is relatively large, based on the tracking reference signal received from the base station 200. Accordingly, the terminal 100 may set a larger bit size (second size) to store the variation between the first channel characteristic information and the second channel characteristic information.

According to one or more example embodiments, the terminal 100 may adaptively change a gap (e.g., an interval or spacing) or the number of reference resource units or pivot resource units in which the entire (full) corresponding channel characteristic information is stored. More specifically, the terminal 100 may adaptively determine a gap or the number of the pivot resource units based on a precoding resource block group (PRG) unit, a size of a buffer (e.g., available buffer capacity), or a size of bits in which channel characteristic information is stored, and the like. This adaptive configuration may enable efficient trade-offs between memory usage and channel estimation accuracy.

For example, the terminal 100 may set the gap of resource units smaller than that of the PRG units by considering continuity of a channel. Alternatively, when a size of a buffer in which a plurality of pieces of channel information can be stored is relatively large, the terminal 100 may set the number of the pivot resource units higher than when the size of the buffer is relatively small. When a size of bits in which channel characteristic information is stored is relatively small, the terminal 100 may set the number of pivot resource units higher than when the size of the bit is relatively large.

In operation S235, the terminal 100, by performing interpolation based on the first channel characteristic information and the second characteristic information, may identify the plurality of pieces of channel characteristic information corresponding to a plurality of resource units between the first resource unit and the second resource unit.

As an example, the terminal 100 may calculate the plurality of pieces of channel characteristic information corresponding to the plurality of resource units between the first resource unit and the second resource unit by performing linear interpolation or minimum mean square error (MMS) in a frequency domain based on the first channel characteristic information and the second channel characteristic information.

As another example, the terminal 100 may calculate the plurality of pieces of channel characteristic information corresponding to the plurality of resource units between the first resource unit and the second resource unit by performing linear interpolation or MMS in a time domain based on the first channel characteristic information and the second channel characteristic information.

In operation S240, the terminal 100 may identify variations in channel characteristic information corresponding to adjacent resource units among the first resource unit, the plurality of resource units, and the second resource unit according to one or more example embodiments. For example, the terminal 100 may calculate a difference between channel characteristic information corresponding to adjacent resource units for each of a real value and an imaginary value as shown in equation (4).

$$\{ \begin{matrix}\begin{matrix}Delt {a}_{I} ( n ) = {\hat{h}}_{I} ( n + 1 ) - {\hat{h}}_{I} ( n ) = {I}_{n + 1} - {I}_{n} \\ Delt {a}_{Q} ( n ) = {\hat{h}}_{Q} ( n + 1 ) - {\hat{h}}_{Q} ( n ) = {Q}_{n + 1} - {Q}_{n}\end{matrix} & n = 1 , 2 , 3 ,\end{matrix} \qquad ( 4 )$$

In the context that ĥ₁(n) and ĥ_{Q}(n) denote in-phase (I) and quadrature (Q) components of the estimated channel characteristic information ĥ(n), respectively, for the n-th resource unit, the terminal 100 may calculate the differences Delta₁(n) and Delta_{Q}(n) by subtracting the I and Q components of the estimated channel characteristic information between the (n+1)-th and n-th resource units to detect changes in the channel characteristics across adjacent resource units.

In operation S245, the terminal 100 may store the information on variations between channel characteristic information as channel characteristic information corresponding to the plurality of resource units according to one or more example embodiments. More specifically, the terminal 100 may store the information on variations between channel characteristic information in bits of the second size as channel characteristic information corresponding to the plurality of resource units.

For example, the terminal 100 may store Iₙ-Iₙ₋₁ and Qₙ-Qₙ₋₁ in the buffer as 7 bits each as channel characteristic information corresponding to the nth resource unit.

However, when the terminal 100 performs interpolation in real-time to restore data, operations S240 and S245 may be omitted.

In operation S250, the terminal 100 may identify channel characteristic information corresponding to the plurality of resource units based on the information on variations between channel characteristic information according to one or more example embodiments. For example, the terminal 100 may calculate channel characteristic information corresponding to the plurality of resource units by adding a difference to the channel characteristic information corresponding to an adjacent resource unit as shown in equation (5).

$$\{ \begin{matrix}\begin{matrix}{I}_{n} = {\hat{h}}_{I} ( n ) = D e l t {a}_{I} ( n - 1 ) + {\hat{h}}_{I} ( n - 1 ) = D e l t {a}_{I} ( n - 1 ) + {I}_{n - 1} \\ \begin{matrix}{Q}_{n} = {\hat{h}}_{Q} ( n ) = D e l t {a}_{Q} ( n - 1 ) - {\hat{h}}_{Q} ( n - 1 ) = \\ {Delta}_{Q} ( n - 1 ) + {Q}_{n - 1}\end{matrix}\end{matrix} & n = 2 , 3 ,\end{matrix} \qquad ( 5 )$$

In Equation (5), ĥ₁(n) and ĥ_{Q}(n), which denote the in-phase (I) and quadrature (Q) components of the estimated channel characteristic information for the n-th resource unit, are obtained by adding the respective differences Delta₁(n-1) and Delta_{Q}(n-1) to the I and Q components of the preceding (n-1)-th resource unit. This recursive process may allow the terminal 100 to reconstruct the full sequence of channel characteristic information across the plurality of resource units.

In operation S255, the terminal 100 may restore data based on the plurality of pieces of channel characteristic information according to one or more example embodiments. More specifically, the terminal 100 may acquire data by acquiring a plurality of second symbol values, by identifying a plurality of first symbol values included in the plurality of resource units and performing channel equalization on the plurality of first symbols, and demodulating the plurality of second symbols.

For example, the terminal 100 may identify PDSCH data or a symbol value included in the nth resource unit and acquire a corrected symbol value using channel characteristic information corresponding to the nth resource unit as shown in equation (6). Then, the terminal 100 may identify a bit value corresponding to the corrected symbol value based on information on the modulation method used as well as a coding rate, included in the indication information.

$${\hat{x}}_{data} ( n ) = \frac{{y}_{d a t a} ( n )}{\hat{h} ( n )} \qquad ( 6 )$$

Here, y_{data}(n) denotes the PDSCH data or the symbol value the terminal 100 received, ĥ(n) denotes channel characteristic information, and \hat{x}_{data}(n) denotes the corrected symbol value. Also, the information on the modulation method used and coding rate included in the indication information may include information on quadrature phase shift keying (QPSK), 16-quadrature amplitude modulation (16-QAM), 64-QAM, or 256-QAM, but this is merely an example, and is not limited to the above description.

In operation S260, the terminal 100 may delete the plurality of pieces of channel characteristic information stored in the buffer based on a predetermined interval according to one or more example embodiments. For example, the terminal 100 may flush the plurality of pieces of channel characteristic information stored in the buffer at each predetermined interval. However, the interval of the terminal 100 deleting channel characteristic information stored in the buffer is not limited to the above description.

According to one or more example embodiments, the terminal 100 may adaptively change the predetermined interval based on various parameters. More specifically, the terminal 100 may adaptively determine the interval of deleting the plurality of pieces of channel characteristic information based on a size of the buffer or a size of bits in which channel characteristic information is stored.

For example, when the size of the buffer in which the plurality of pieces of channel characteristic information is stored is relatively large, the predetermined interval may be set longer compared to when the buffer size is relatively small. Alternatively, when the size of the bit in which channel characteristic information is stored is relatively small, the predetermined interval may be set longer compared to when the bit size is relatively small.

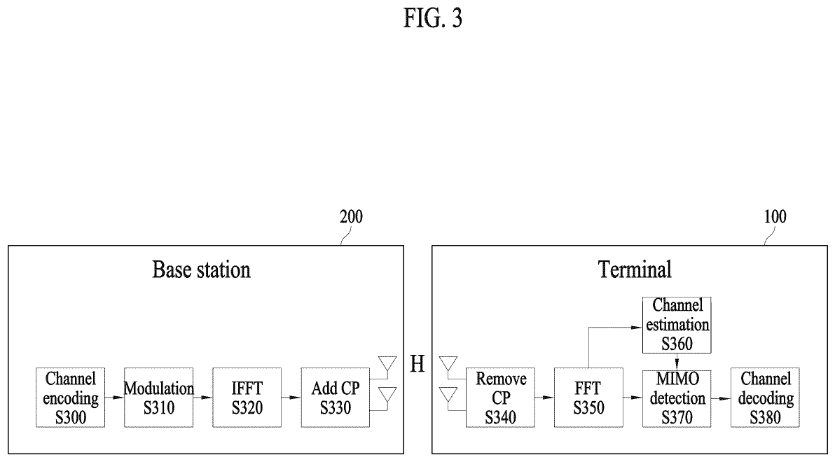

FIG. 3 is a diagram illustrating a reception structure of a MIMO ODFM system according to one or more example embodiments.

In operation S300, the base station 200 may perform channel encoding according to one or more example embodiments. For example, the base station 200 may add a code (e.g., an error-correcting code) that allows for error detection and correction to make data to the transmission data to be more error-tolerant. Here, the base station 200 may perform encoding using convolutional coding, low density parity check (LDPC) coding, or turbo coding, but this is merely an example, and is not limited to the above description.

In operation S310, the base station 200 may perform modulation according to one or more example embodiments. For example, the base station 200 may convert or map encoded bit sequences into modulation symbols using a predetermined modulation method.

In operation S320, the base station 200 may perform inverse discrete fourier transform (IFFT) according to one or more example embodiments. For example, the base station 200 may generate an orthogonal frequency division multiplexing (OFDM) signal by converting modulation data in a frequency domain into a time domain.

In operation S330, the base station 200 may add a cyclic prefix (CP) according to one or more example embodiments. For example, the base station 200 may add CP in front of each OFDM symbol to ease multipath fading to reduce an intersymbol interference and allow stable transmission of data in a frequency selective environment.

In operation S340, the terminal 100 may remove the CP according to one or more example embodiments. For example, the terminal 100 may restore an original OFDM symbol by removing the CP from a signal received.

In operation S350, the terminal 100 may perform discrete fourier transform (FFT) according to one or more example embodiments. For example, the terminal 100 may restore information on each subcarrier by converting a time domain signal into a frequency domain.

In operation S360, the terminal 100 may perform channel estimation according to one or more example embodiments. For example, the terminal 100 may acquire channel characteristic information based on a reference signal received from the base station.

In operation S370, the terminal 100 may perform multiple-input and multiple-output (MIMO) detection according to one or more example embodiments. For example, the terminal 100 may calculate a log likelihood ratio (LLR) based on channel characteristic information.

In operation S380, the terminal 100 may perform channel decoding according to one or more example embodiments. For example, the terminal 200 may restore original data using the calculated LLR.

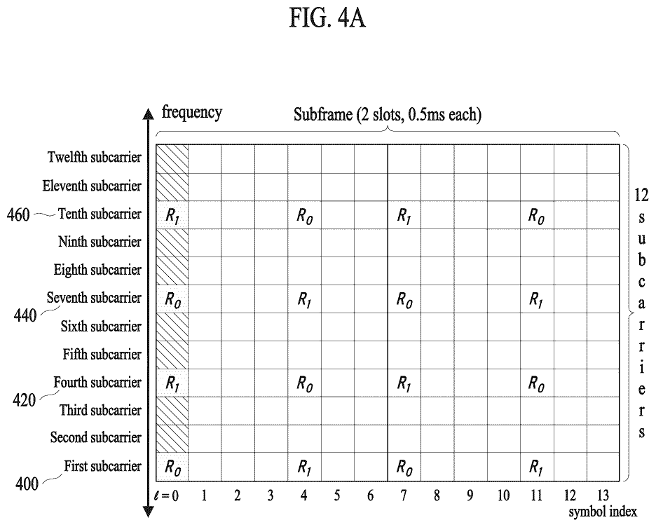

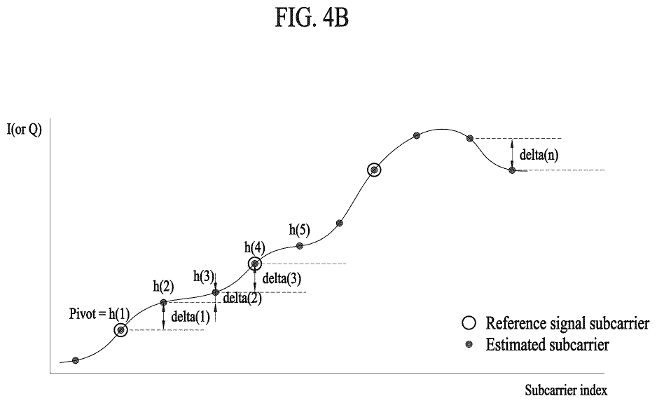

FIGS. 4A and 4B are diagrams for describing a process of the terminal 100 storing channel characteristic information in a frequency domain according to one or more example embodiments. A description overlapping with the above descriptions with reference to FIG. 2 will be described briefly or omitted.

According to one or more example embodiments, the terminal 100 may identify a plurality of reference signals included in a resource group. For example, referring to FIG. 4A, the terminal 100 may identify, within an assigned resource group, a first subcarrier 400, a fourth subcarrier 420, a seventh subcarrier 440, and tenth subcarrier 460 in which reference signals are located, based on reference signal settings information.

According to one or more example embodiments, the terminal 100 may identify channel characteristic information corresponding to a subcarrier including a reference signal, based on a plurality of reference signals and a plurality of predefined reference signals. For example, referring to FIG. 4A, the terminal 100, by comparing a predefined reference signal with a reference signal received from the base station 200, may identify first channel characteristic information, fourth channel characteristic information, seventh channel characteristic information, and tenth channel characteristic information corresponding to the first subcarrier 400, the fourth subcarrier 420, the seventh subcarrier 440, and the tenth subcarrier 460 respectively.

According to one or more example embodiments, the terminal 100 may identify channel characteristic information corresponding to a subcarrier between subcarriers including reference signals, by performing interpolation in a frequency domain. For example, referring to FIG. 4A, the terminal 100 may identify second channel characteristic information and third channel characteristic information corresponding to a second subcarrier and a third subcarrier between the first subcarrier 400 and the fourth subcarrier 420, by performing interpolation based on the first channel characteristic information and the fourth channel characteristic information. Alternatively, referring to FIG. 4A, the terminal 100, by performing interpolation based on the fourth channel characteristic information and the seventh characteristic information, may identify fifth channel characteristic information and sixth channel characteristic information corresponding to a fifth subcarrier and a sixth subcarrier between the fourth subcarrier 420 and the seventh subcarrier 440. Referring to FIG. 4A, the terminal 100, by performing interpolation based on the seventh channel characteristic information and the tenth characteristic information, may identify eighth channel characteristic information and ninth channel characteristic information corresponding to an eight subcarrier and a ninth subcarrier between the seventh subcarrier 440 and the tenth subcarrier 460. Referring to FIG. 4A, the terminal 100, by performing interpolation based on the tenth channel characteristic information, may identify eleventh channel characteristic information and twelfth channel characteristic information corresponding to an eleventh subcarrier and a twelfth subcarrier.

According to one or more example embodiments, the terminal 100 may identify variation between channel characteristic information. For example, referring to FIG. 4B, the terminal 100 may calculate a difference between channel characteristic information corresponding to adjacent subcarriers for each of a real value and an imaginary value.

According to one or more example embodiments, the terminal 100 may store information on variations between channel characteristic information as channel characteristic information corresponding to a plurality of subcarriers. For example, the terminal 100 may store the first channel characteristic information in bits of the first size for each of a real value and an imaginary value as the first channel characteristic information corresponding to the first subcarrier 400, which may become a reference or pivoted. In addition, the terminal 100 may store a difference between the second channel characteristic information and the first channel characteristic information for each of a real value and an imaginary value in bits of the second size as the second channel characteristic information corresponding to the second subcarrier. Similarly, the terminal 100 may store a difference between channel characteristic information corresponding to an adjacent subcarrier for each of a real value and an imaginary value as channel characteristic information corresponding to the third to twelfth subcarriers.

Meanwhile, although the terminal 100 is illustrated as estimating and storing channel characteristic information for a symbol corresponding to l=0 value only, this is merely an example, and the terminal 100 may estimate channel characteristic information on all symbols corresponding to l=0 through l=13 values and store a difference between pieces of channel characteristic information corresponding to adjacent subcarriers. Here, l denotes a symbol index within a slot or subframe in an OFDM-based system. For example, l=0 refers to the first OFDM symbol in a subframe, and l=13 refers to the 14th symbol in the subframe.

Accordingly, by storing the difference between channel characteristic information corresponding to adjacent subcarriers instead of storing the entire channel characteristic information corresponding to each subcarrier, a size of a buffer required to store channel characteristic information may be reduced.

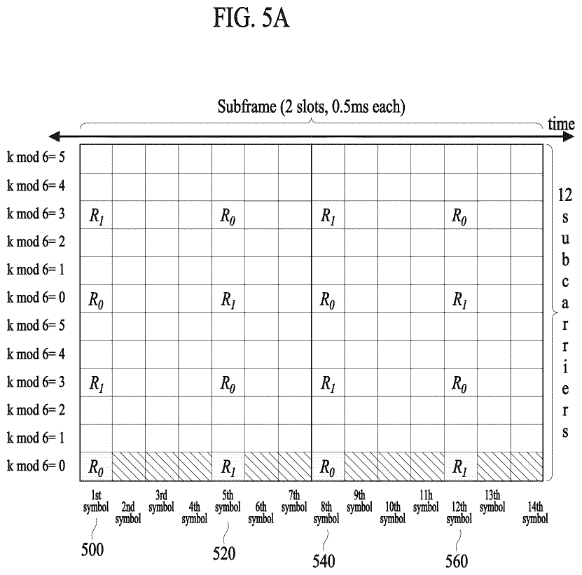

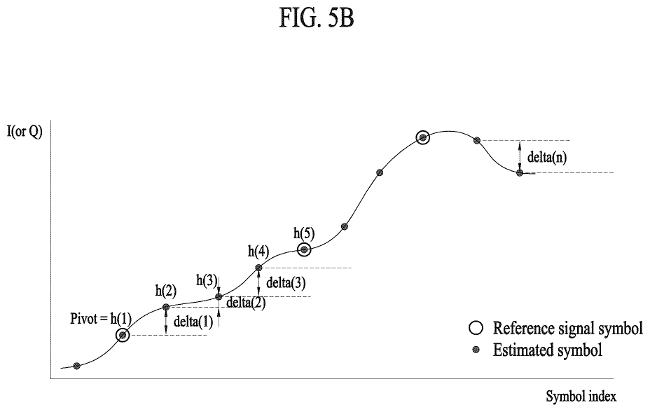

FIGS. 5A and 5B are diagrams for describing a process of the terminal 100 storing channel characteristic information in a time domain according to one or more example embodiments. A description overlapping with the above descriptions with reference to FIG. 2 will be described briefly or omitted.

According to one or more example embodiments, the terminal 100 may identify a plurality of reference signals included in a resource group. For example, referring to FIG. 5A, the terminal 100 may identify, from an assigned resource group, a first symbol 500, a fifth symbol 520, an eighth symbol 540, and a twelfth symbol 560 in which reference signals are located, based on reference signal settings information.

According to one or more example embodiments, the terminal 100 may identify channel characteristic information corresponding to a symbol that includes a reference signal, based on a plurality of reference signals and a plurality of predefined reference signals. For example, referring to FIG. 5A, the terminal 100, by comparing a predefined reference signal with a reference signal received from the base station 200, may identify first channel characteristic information, fifth channel characteristic information, eighth channel characteristic information, and twelfth channel characteristic information corresponding to the first symbol 500, the fifth symbol 520, the eighth symbol 540, and the twelfth symbol 560 respectively.

According to one or more example embodiments, the terminal 100 may identify channel characteristic information corresponding to a subcarrier between subcarriers which include reference signals by performing interpolation in a frequency domain. For example, referring to FIG. 5A, the terminal 100, by performing interpolation based on the first channel characteristic information and the fifth channel characteristic information, may identify second channel characteristic information to fourth channel characteristic information corresponding to a second symbol to a fourth symbol between the first symbol 500 and the fifth symbol 520. Alternatively, referring to FIG. 5A, the terminal 100, by performing interpolation based on the fifth channel characteristic information and the eighth channel characteristic information, may identify sixth channel characteristic information and seventh channel characteristic information corresponding to a sixth symbol and a seventh symbol between the fifth symbol 520 and the eight symbol 540. Referring to FIG. 5A, the terminal 100, by performing interpolation based on the eighth channel characteristic information and the twelfth channel characteristic information, may identify ninth channel characteristic information and eleventh channel characteristic information corresponding to a ninth symbol and an eleventh symbol between the eighth symbol 540 and the twelfth symbol 560. Referring to FIG. 5A, the terminal 100, by performing interpolation based on the twelfth channel characteristic information, may identify thirteenth channel characteristic information and fourteenth channel characteristic information corresponding to a thirteenth symbol and a fourteenth symbol.

According to one or more example embodiments, the terminal 100 may identify variation between channel characteristic information. For example, referring to FIG. 5B, the terminal 100 may calculate a difference between channel characteristic information corresponding to adjacent symbols for each of a real value and an imaginary value.

According to one or more example embodiments, the terminal 100 may store information on variations between channel characteristic information as channel characteristic information corresponding to a plurality of symbols. For example, the terminal 100 may store the first channel characteristic information for each of a real value and an imaginary value in bits of the first size as the first channel characteristic information corresponding to the first symbol 500 which may become a reference or pivoted. In addition, the terminal 100 may store a difference between the second channel characteristic information and the first channel characteristic information in bits of the second size for each of a real value and an imaginary value as the second channel characteristic information corresponding to the second symbol. Similarly, the terminal 100 may store a difference between channel characteristic information corresponding to adjacent symbols for each of a real value and an imaginary value as channel characteristic information corresponding to the third symbol to the twelfth symbol.

Meanwhile, although in FIG. 5A the terminal 100 is illustrated as estimating and storing channel characteristic information only for a subcarrier corresponding to the k mod 6=0 value, this is merely an example, and the terminal 100 may estimate channel characteristic information on all subcarriers corresponding to k mod 6=0 to k mod 6=5 values and store differences between channel characteristic information corresponding to adjacent symbols.

Accordingly, the terminal 100 may reduce size of a buffer required to store channel characteristic information by storing differences between channel characteristic information corresponding to adjacent symbols, instead of storing the entire channel characteristic information corresponding to each symbol.

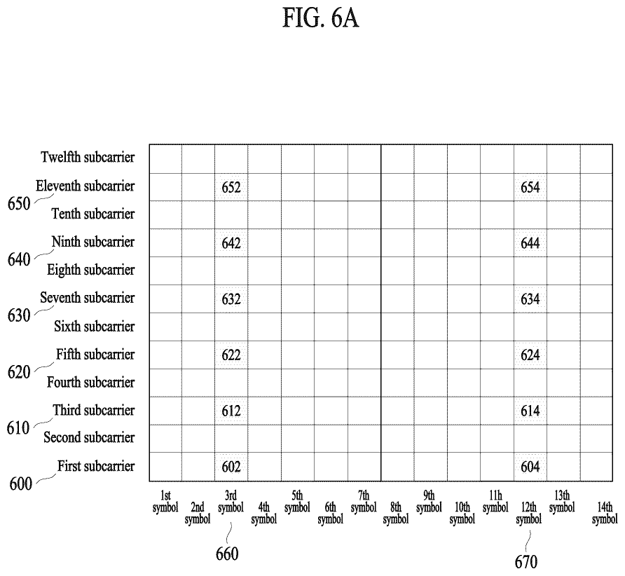

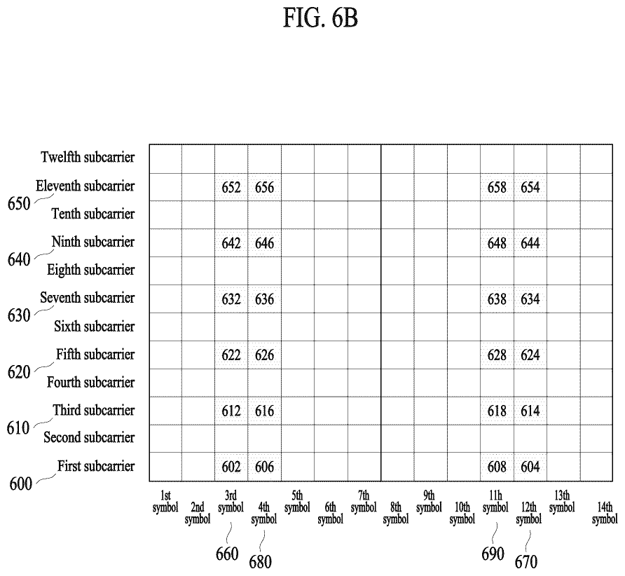

FIGS. 6A and 6B are diagrams for describing a process of the terminal 100 storing channel characteristic information according to one or more example embodiments. A description overlapping with the above descriptions with reference to FIG. 2 will be described briefly or omitted.

According to one or more example embodiments, the terminal 100 may identify a plurality of reference signals included in a resource group. More specifically, the terminal 100 may identify a plurality of reference signals included in a resource group based on reference signal settings information.

As an example, referring to FIG. 6A, the terminal 100 may identify that a value of a reference signal settings type is set as a first value and a value of a reference signal length is set as the first value based on the reference signal settings information. Accordingly, the terminal 100 may identify that, within an assigned resource group, resource units 602, 604, 612, 614, 622, 624, 632, 634, 642, 644, 652, and 654, corresponding to a third symbol 660, a twelfth symbol 670, and a first subcarrier 600, a third subcarrier 610, a fifth subcarrier 620, a seventh subcarrier 630, a ninth subcarrier 640, and an eleventh subcarrier 650 include reference signals.

As another example, referring to FIG. 6A, the terminal 100 may identify that a value of a reference signal settings type is set as a first value and a value of a reference signal length is set as a second value based on reference signal settings information. Accordingly, the terminal 100 may identify, within an assign resource group, that resource units 602, 604, 606, 608, 612, 614, 616, 618, 622, 624, 626, 628, 632, 634, 636, 638, 642, 644, 646, 648, 652, 654, 656, and 658, corresponding to the third symbol 660, a fourth symbol 680, an eleventh symbol 690, and the twelfth symbol 670 and the first subcarrier 600, the third subcarrier 610, the fifth subcarrier 620, the seventh subcarrier 630, the ninth subcarrier 640, and the eleventh subcarrier 650 include reference signals.

According to one or more example embodiments, the terminal 100 may identify channel characteristic information corresponding to a resource unit that include a reference signal, based on a plurality of reference signals and a plurality of predefined reference signals. As an example, referring to FIG. 6A, the terminal 100 may identify a plurality of pieces of channel characteristic information corresponding to resource units 602, 604, 612, 614, 622, 624, 632, 634, 642, 644, 652, and 654, by comparing a predefined reference signal with a reference signal received from the base station 200. Alternatively, referring to FIG. 6B, the terminal 100 may identify a plurality of pieces of channel characteristic information corresponding to 602, 604, 606, 608, 612, 614, 616, 618, 622, 624, 626, 628, 632, 634, 636, 638, 642, 644, 646, 648, 652, 654, 656, and 658, by comparing a predefined reference signal with a reference signal received from the base station 200.

According to one or more example embodiments, the terminal 100 may identify variation between channel characteristic information.

For example, referring to FIG. 6A, the terminal 100 may calculate a difference between channel characteristic information of the resource unit 604 and channel characteristic information of the resource unit 602, for each of a real value and an imaginary value. Accordingly, the terminal 100 may perform the same operation on resource units 612, 614, 622, 624, 632, 634, 642, 644, 652, and 654.

As another example, referring to FIG. 6B, the terminal 100 may calculate a difference between channel characteristic information of the resource unit 602 and channel characteristic information of the resource unit 606, a difference between channel characteristic information of the resource unit 606 and channel characteristic information of the resource unit 608, and a difference between channel characteristic information of the resource unit 608 and channel characteristic information of the resource unit 604, for each of a real value and an imaginary value. Similarly, the terminal 100 may perform the same operation on resource units 612, 614, 616, 618, 622, 624, 626, 628, 632, 634, 636, 638, 642, 644, 646, 648, 652, 654, 656, and 658.

According to one or more example embodiments, the terminal 100 may store information on variations between channel characteristic information as channel characteristic information corresponding to a plurality of resource units.

As an example, referring to FIG. 6A, the terminal 100 may store channel characteristic information corresponding to the resource unit 602, which may become a reference or pivoted, in bits of the first size for each of a real value and an imaginary value. Also, the terminal 100 may store a difference between channel characteristic information corresponding to the resource unit 602 and channel characteristic information corresponding to the resource unit 604 in bits of the second size for each of a real value and an imaginary value. The terminal 100 may store a difference between channel characteristic information corresponding to the resource unit 612 and channel characteristic information corresponding to the resource unit 602 in bits of the second size for each of a real value and an imaginary value. Meanwhile, the terminal 100 may store a difference between channel characteristic information corresponding to the resource unit 614 and channel characteristic information corresponding to the resource unit 612 in bits of the second size for each of a real value and an imaginary value, or store a difference between channel characteristic information corresponding to the resource unit 614 and channel characteristic information corresponding to the resource unit 604 in bits of the second size for each of a real value and an imaginary value, as channel characteristic information corresponding to the resource unit 614. Similarly, the terminal 100 may store channel characteristic information corresponding to resource units 622, 624, 632, 634, 642, 644, 652, and 654, in bits of the second size.

As another example, the terminal 100 may store channel characteristic information corresponding to the resource unit 602, which may become a reference or pivoted, in bits of the first value for each of a real value and an imaginary value. In addition, the terminal 100 may store a difference between channel characteristic information corresponding to the resource unit 602 and channel characteristic information corresponding to the resource unit 606 as channel characteristic information corresponding to the resource unit 606 in bits of the second size, store a difference between channel characteristic information corresponding to the resource unit 608 and channel characteristic information corresponding to the resource unit 606 as channel characteristic information corresponding to the resource unit 608 in bits of the second size, and store a difference between channel characteristic information corresponding to the resource unit 604 and channel characteristic information corresponding to the resource unit 608 as channel characteristic information corresponding to the resource unit 604 in bits of the second size, for each of a real value and an imaginary value. The terminal 100 may store a difference between channel characteristic information corresponding to the resource unit 612 and channel characteristic information corresponding to the resource unit 602 in bits of the second size for each of a real value and an imaginary value. Meanwhile, the terminal 100 may store a difference between channel characteristic information corresponding to the resource unit 616 and channel characteristic information corresponding to the resource unit 612 in bits of the second size for each of a real value and an imaginary value, or store a difference between channel characteristic information corresponding to the resource unit 616 and channel characteristic information corresponding to the resource unit 606 in bits of the second size for each of a real value and an imaginary value, as channel characteristic information corresponding to the resource unit 616. Similarly, the terminal 100 may store channel characteristic information corresponding to resource units 614, 618, 622, 624, 626, 628, 632, 634, 636, 638, 642, 644, 646, 648, 652, 654, 656, and 658, in bits of the second size.

According to one or more example embodiments, the terminal 100 may adaptively determine a size of bits in which channel characteristic information is stored, based on reference signal settings information. For example, the terminal 100 may identify that the number of reference signals is higher in the case illustrated in FIG. 6B than in the case illustrated in FIG. 6A based on values of a reference signal settings type and a reference signal length. Accordingly, the terminal 100 may determine the second size, in which information on variation between channel characteristic information is stored, to be relatively smaller in the case illustrated in FIG. 6B than in the case illustrated in FIG. 6A.

According to one or more example embodiments, the terminal 100 may adaptively determine a size of bits differently, in which channel characteristic information is stored, based on reference signal settings information. More specifically, the terminal 100 may identify gaps between resource units that include reference signals, based on the reference signal settings information, and determine sizes of bits, in which variation between channel characteristic information is stored, differently, based on the gap between the resource units.

For example, referring to FIG. 6B, the terminal 100 may identify that a gap between the resource units 602 and 606, which include reference signals, is smaller than a gap between the resource units 606 and 608. Accordingly, the terminal 100 may store a difference between channel characteristic information corresponding to the resource unit 602 and channel characteristic information corresponding to the resource unit 606 in relatively smaller bits than a difference between channel characteristic information corresponding to the resource unit 606 and channel characteristic information corresponding to the resource unit 608.

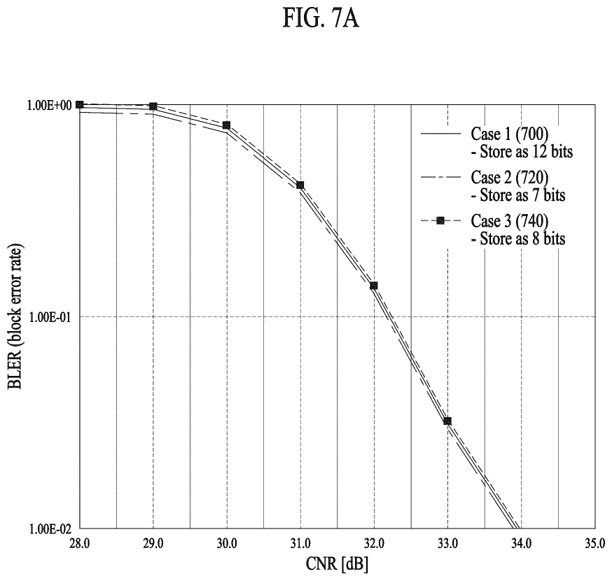

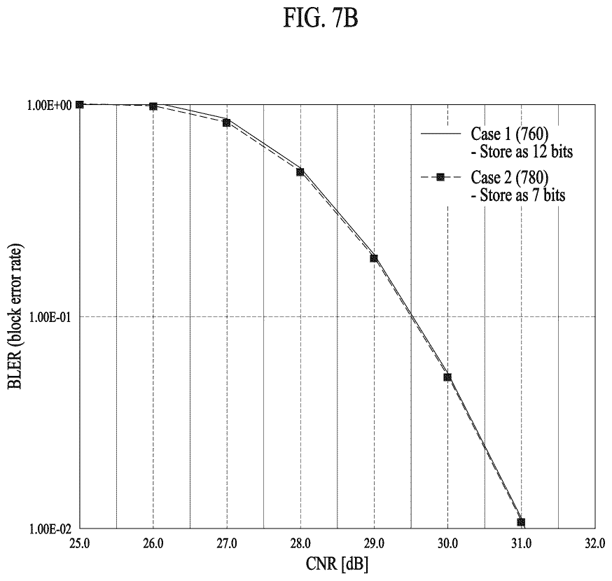

FIGS. 7A and 7B are diagrams for describing a result of an operation method executed in the terminal 100 according to one or more example embodiments.

According to one or more example embodiments, the terminal 100 may identify a difference between channel characteristic information in a frequency domain and store the difference between channel characteristic information in bits of a relatively smaller size than the channel characteristic information. For example, in Case 1 represented by reference number 700, the terminal 100 may store the entire channel characteristic information using 12 bits. Alternatively, in Case 2 represented by reference number 720, the terminal 100 may store the entire channel characteristic information corresponding to a pivot resource unit only, using 12 bits, and with respect to channel characteristic information corresponding to other resource units, the terminal 100 may store a difference between channel characteristic information corresponding to an adjacent resource unit using 7 bits. In Case 3 represented by reference number 740, the terminal 100 may store the entire channel characteristic information only for a pivot resource unit, using 12 bits, and with respect to channel characteristic information corresponding to other resource units, may store only a difference in channel characteristic information relative to an adjacent resource unit, using 8 bits.

Here, FIG. 7A is a diagram illustrating performances or yields of each of the Case 1 represented by reference number 700, the Case 2 represented by reference number 720, and the Case 3 represented by reference number 740, and one can identify that the performance is still maintained even when a difference between channel characteristic information is stored in bits of relatively smaller size than that of the channel characteristic information.

According to one or more example embodiments, the terminal 100 may identify a difference between channel characteristic information in a time domain, and store the difference between channel characteristic information in a relatively small size than that of the channel characteristic information. For example, in Case 1 represented by reference number 760, the terminal 100 may store the entire channel characteristic information as 12 bits. Alternatively, in Case 2 represented by reference number 780, the terminal 100 may store the entire channel characteristic information corresponding to a pivot resource unit only, using 12 bits, and with respect to channel characteristic information corresponding to other resource units, the terminal 100 may store a difference between channel characteristic information corresponding to an adjacent resource unit using 7 bits.

Here, FIG. 7B is a diagram illustrating performances and yields for each of the Case 1 represented by reference number 760 and the Case 2 represented by reference number 780, and one can identify that the performance is still maintained even when a difference between channel characteristic information is stored in bits of relatively smaller size than that of the channel characteristic information.

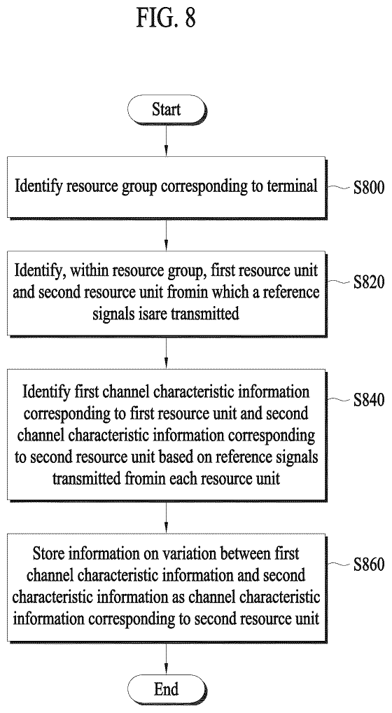

FIG. 8 is a flowchart illustrating an operation method of a terminal according to one or more example embodiments. The above-described descriptions may be applied to a redundant description.

In operation S800, a terminal may identify a resource group corresponding to the terminal.

In operation S820, the terminal may identify a first resource unit and a second resource unit within the resource group, in which reference signals are transmitted.

In operation S840, the terminal may identify first channel characteristic information corresponding to the first resource unit and second channel characteristic information corresponding to the second resource unit, based on reference signals transmitted in each resource unit.

According to one or more example embodiments, the first channel characteristic information may be determined based on a first reference signal transmitted in the first resource unit, and the second channel characteristic information may be determined based on a second reference signal transmitted in the second resource unit.

According to one or more example embodiments, by performing interpolation in a frequency domain based on the first channel characteristic information and the second channel characteristic information, the terminal may identify a plurality of pieces of channel characteristic information corresponding to each of a plurality of resource units between the first resource unit and the second resource unit, identify variations between channel characteristic information corresponding to adjacent resource units among the first resource unit, the plurality of resource units, and the second resource unit, and store information on the variations between channel characteristic information as channel characteristic information corresponding to the plurality of resource units.

According to one or more example embodiments, the terminal may acquire data by acquiring a plurality of second symbol values which channel distortion is corrected, by identifying a plurality of first symbol values included in the plurality of resource units and performing equalization on the plurality of first symbol values based on a plurality of pieces of channel characteristic information, and demodulating the plurality of symbol values.

According to one or more example embodiments, the terminal may identify a plurality of pieces of channel characteristic information corresponding to each of the plurality of resource units between the first resource unit and the second resource unit by performing interpolation in a time domain based on the first channel characteristic information and the second channel characteristic information, identify variations between channel characteristic information corresponding to adjacent resource units among the first resource unit, the plurality of resource units, and the second resource unit, and store the information on variations in channel characteristic information as channel characteristic information corresponding to the plurality of resource units.

According to one or more example embodiments, the terminal may acquire data by acquiring a plurality of second symbol values with channel distortion corrected, by identifying a plurality of first symbol values included in the plurality of resource units and performing equalization on the plurality of first symbol values based on a plurality of pieces of channel characteristic information, and demodulating the plurality of symbol values.

According to one or more example embodiments, the first channel characteristic information may include a first real value and a first imaginary value and the second channel characteristic information may include a second real value and a second imaginary value, and variation between the first channel characteristic information and the second channel characteristic information may include a difference between the first real value and the second real value, and a difference between the first imaginary value and the second imaginary value.

In operation S860, the terminal may store information on variation between the first channel characteristic information and the second channel characteristic information as channel characteristic information corresponding to the second resource unit.

According to one or more example embodiments, the first channel characteristic information may be stored in bits of a first size, and the information on variation between the first channel characteristic information and the second channel characteristic information may be stored in bits of a second size.

According to one or more example embodiments, the second size may be set as a fixed value smaller than the first size.

According to one or more example embodiments, the terminal, based on a tracking reference signal, may estimate a changing trend of channel characteristic information corresponding to a resource group, and the second size may be adaptively determined based on the changing trend of the channel characteristic information.

According to one or more example embodiments, channel characteristic information corresponding to the second resource unit may be stored in a buffer of the terminal, and the terminal may delete the channel characteristic information stored in the buffer at a set period.

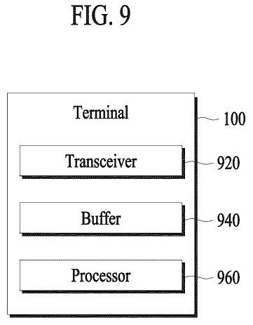

FIG. 9 is a block diagram of the terminal 100 according to one or more example embodiments.

According to one or more example embodiments, the terminal 100 may include a transceiver 920, a buffer 940, and a processor 960. Components related to the example embodiment are shown with respect to the terminal 100 illustrated in FIG. 9, and additional components other than the components illustrated in FIG. 9 may also be included. According to example embodiments, the transceiver 920 may be included in a communication device. Also, according to example embodiments, the processor 960 may be included in a controller.

The transceiver 920, as a component for wire/wireless communication, may communicate with an external terminal. The external terminal may be an electronic device or a server. Also, the transceiver 920 may support global system for mobile communication (GSM), code division multi-access (CDMA), long-term evolution (LTE), 5G, wireless local access memory (WLAN), wireless-fidelity (Wi-Fi), Bluetooth™, radio frequency identification (RFID), infrared data association (IrDA), ZigBee, near field communication (NFC), and the like.

The buffer 940, as a component for storing channel characteristic information, may be included in a modem within the terminal 100 or included as a component of the transceiver 920 or the processor 960, however, this is merely an example, and the buffer 940 may exist outside the modem.

The processor 960 may control overall operations of the terminal 100 and process data and a signal. The processor 960 may be configured as at least one hardware unit. In addition, the processor 960 may be operated by one or more software modules created by executing a program code stored in the buffer 940. Since the processor 960 may include a memory, the processor 960 may execute a program code stored in the buffer 940 and control overall operations of the terminal 100 and process data and a signal.

The processor 960 may identify a resource group corresponding to the terminal, identify a first resource unit and a second resource unit within the resource group, in which reference signals are transmitted, identify first channel characteristic information corresponding to the first resource unit and second channel characteristic information corresponding to the second resource unit based on reference signals transmitted in each resource unit, and store information on variation between the first channel characteristic information and the second characteristic information as channel characteristic information corresponding to the second resource unit.

The terminal 100 in accordance with the example embodiments described above may include a processor, a memory which stores and executes program data, a permanent storage such as a disk drive, a communication port for communication with an external device, and a user interface device such as a touch panel, a key, and a button. Methods realized by software modules or algorithms may be stored in a computer-readable recording medium as computer-readable codes or program commands which may be executed by the processor. The computer-readable recording medium may be a magnetic storage medium (e.g., read-only memory (ROM), random-access memory (RAM), floppy disk, hard disk, and etc.))) and an optical reading medium (e.g., CD-ROM, digital versatile disc (DVD)), and etc. The computer-readable recording medium may be dispersed to computer systems connected by a network so that computer-readable codes may be stored and executed in a dispersion manner. The medium may be read by a computer, stored in a memory, and executed by a processor.

The example embodiments may be represented by functional blocks and various processing steps. These functional blocks may be implemented by different numbers of hardware and/or software configurations that execute specific functions. For example, the example embodiments may adopt direct circuit configurations such as a memory, a processor, a logic circuit, and a look-up table that may execute various functions by control of one or more microprocessors or other control devices. Similarly to that elements may be executed by software programming or software elements, the example embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the example embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

The example embodiments described above are mere examples and other embodiments may be implemented within the scope of the following claims.

What is claimed is:

1. An operation method performed by a terminal, the operation method comprising:
identifying a resource group corresponding to the terminal;
identifying, within the resource group, a first resource unit and a second resource unit;
identifying first channel characteristic information corresponding to the first resource unit and second channel characteristic information corresponding to the second resource unit based on reference signals transmitted in the first resource unit and the second resource unit; and
storing information indicating a variation between the first channel characteristic information and the second channel characteristic information as the second channel characteristic information corresponding to the second resource unit.

2. The operation method of claim 1,
wherein the first channel characteristic information is stored in bits of a first size, and
wherein the information indicating the variation between the first channel characteristic information and the second channel characteristic information is stored in bits of a second size.

3. The operation method of claim 2, wherein the second size is set to be smaller than the first size.

4. The operation method of claim 2, further comprising estimating a variation trend of channel characteristic information corresponding to the resource group based on a tracking reference signal, and
wherein the second size is adaptively determined based on the variation trend of the channel characteristic information corresponding to the resource group.

5. The operation method of claim 1,
wherein the reference signals comprise a first reference signal transmitted in the first resource unit and a second reference signal transmitted in the second resource unit,
wherein the first channel characteristic information is determined based on the first reference signal transmitted in the first resource unit, and
wherein the second channel characteristic information is determined based on the second reference signal transmitted in the second resource unit.

6. The operation method of claim 5, further comprising:
identifying a plurality of pieces of channel characteristic information corresponding to each of a plurality of resource units between the first resource unit and the second resource unit, by performing interpolation in a frequency domain based on the first channel characteristic information and the second channel characteristic information;
identifying variations between channel characteristic information corresponding to adjacent resource units among the first resource unit, the plurality of resource units, and the second resource unit; and
storing information on the variations in the channel characteristic information as channel characteristic information corresponding to the plurality of resource units.

7. The operation method of claim 6, further comprising:
identifying a plurality of first symbol values included in the plurality of resource units;
acquiring a plurality of second symbol values in which channel distortion is corrected, by performing channel equalization on the plurality of first symbol values based on the plurality of pieces of channel characteristic information; and
acquiring data by demodulating the plurality of second symbol values.

8. The operation method of claim 5, further comprising:
identifying a plurality of pieces of channel characteristic information corresponding to each of a plurality of resource units between the first resource unit and the second resource unit, by performing interpolation in a time domain based on the first channel characteristic information and the second channel characteristic information;
identifying variations between channel characteristic information corresponding to adjacent resource units among the first resource unit, the plurality of resource units, and the second resource unit; and
storing information on the variations in the channel characteristic information as channel characteristic information corresponding to the plurality of resource units.

9. The operation method of claim 8, further comprising:
identifying a plurality of first symbol values included in the plurality of resource units;
acquiring a plurality of second symbol values in which channel distortion is corrected, by performing channel equalization on the plurality of first symbol values based on the plurality of pieces of channel characteristic information; and
acquiring data by demodulating the plurality of second symbol values.

10. The operation method of claim 1,
wherein the first channel characteristic information includes a first real value and a first imaginary value,
wherein the second channel characteristic information includes a second real value and a second imaginary value, and
wherein a variation between the first channel characteristic information and the second channel characteristic information includes a difference between the first real value and the second real value and a difference between the first imaginary value and the second imaginary value.

11. The operation method of claim 1,
wherein the second channel characteristic information corresponding to the second resource unit is stored in a buffer of the terminal, and
wherein the operation method further comprises deleting previously stored channel characteristic information from the buffer based on a receipt of new channel characteristic information.

12. A terminal comprising:
a transceiver;
a buffer; and
a processor configured to;
identify a resource group corresponding to the terminal,
identify, within the resource group, a first resource unit and a second resource unit,
identify first channel characteristic information corresponding to the first resource unit and second channel characteristic information corresponding to the second resource unit, based on reference signals transmitted in the first resource unit and the second resource unit, and
store information indicating a variation between the first channel characteristic information and the second channel characteristic information as the second channel characteristic information corresponding to the second resource unit.

13. The terminal of claim 12,
wherein the first channel characteristic information is stored in bits of a first size, and
wherein the information indicating the variation between the first channel characteristic information and the second channel characteristic information is stored in bits of a second size.

14. The terminal of claim 13, wherein the second size is set to be smaller than the first size.

15. The terminal of claim 13,
wherein the processor is further configured to estimate a variation trend of channel characteristic information corresponding to the resource group based on a tracking reference signal, and
wherein the second size is adaptively determined based on the variation trend of the channel characteristic information to the resource group.

16. The terminal of claim 12,
wherein the reference signals comprise a first reference signal transmitted in the first resource unit and a second reference signal transmitted in the second resource unit,
wherein the first channel characteristic information is determined based on the first reference signal transmitted in the first resource unit, and
the second channel characteristic information is determined based on the second reference signal transmitted in the second resource unit.

17. The terminal of claim 16, wherein the processor is further configured to:
identify a plurality of pieces of channel characteristic information corresponding to each of a plurality of resource units between the first resource unit and the second resource unit, by performing interpolation in a frequency domain based on the first channel characteristic information and the second channel characteristic information;
identify variations between channel characteristic information corresponding to adjacent resource units among the first resource unit, the plurality of resource units, and the second resource unit; and
store information on the variations in the channel characteristic information as channel characteristic information corresponding to the plurality of resource units.

18. The terminal of claim 17, wherein the processor is further configured to:
identify a plurality of first symbol values included in the plurality of resource units;
acquire a plurality of second symbol values in which channel distortion is corrected, by performing channel equalization on the plurality of first symbol values based on the plurality of pieces of channel characteristic information; and
acquire data by demodulating the plurality of second symbol values.

19. The terminal of claim 12,
wherein the first channel characteristic information includes a first real value and a first imaginary value,
the second channel characteristic information includes a second real value and a second imaginary value, and
a variation between the first channel characteristic information and the second channel characteristic information includes a difference between the first real value and the second real value and a difference between the first imaginary value and the second imaginary value.

20. A wireless communication system comprising:
a terminal and a base station,
wherein the base station is configured to transmit to the terminal, indication information indicating a resource group corresponding to the terminal, and
wherein the terminal is configured to:
identify the resource group based on the indication information received from the base station;
identify, within the resource group, a first resource unit and a second resource unit;
identify first channel characteristic information corresponding to the first resource unit and second channel characteristic information corresponding to the second resource unit based on reference signals transmitted in the first resource unit and the second resource unit; and
store information indicating a variation between the first channel characteristic information and the second channel characteristic information as the second channel characteristic information corresponding to the second resource unit.
